(19) United States
(12) Patent Application Publication
(10) Pub. No.: US 2007/0000544 A1
(43) Pub. Date: Jan. 4, 2007

(54) Valve assembly for positive displacement pumps

(76) Inventor: Steven N. Thompson, Spring, TX (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/173,268

(22) Filed: Jul. 1, 2005

(51) Int. Cl. F16K 15/08

(52) U.S. Cl. 137/516.23

(57) ABSTRACT

A valve assembly for a positive displacement fluid pump is described. The valve assembly includes a valve seat having a central opening formed therein. A closure disc is positioned on the valve seat for closing the central opening. The closure disc is formed of a technical ceramic material. The valve assembly has a generally cylindrical wall including a seat surface. An elastomeric seal is affixed to the seat surface such that the closure disc contacts the elastomeric seal when in a closed position. The ceramic closure disc is made from a technical ceramic material to provide enhanced resistance to corrosion and wear from fluids that flow through the valve assembly.

### FIELD OF THE INVENTION

The present invention relates to positive displacement pumps, and in particular to a valve assembly for use in the suction or discharge ports of such pumps.

### BACKGROUND OF THE INVENTION

During drilling operations such as oil drilling, a drilling “mud” is circulated through the drill head to flush material cut by the drill bit to the surface. The drilling mud also provides a static head above the drill bit to drive the drill bit into the earth as it performs the cutting/drilling operation. A mud pump is used to circulate the drilling mud. A drilling rig typically has two to four mud pumps. The reason for multiple pumps is twofold. The larger the hole being drilled the more mud is required. Also, drilling is a continuous operation and drilling stoppages adversely affect productivity and costs. Therefore, one pump is normally maintained as a stand-by unit. This is the case on a rig with three or four pumps. A two pump rig usually has one pump in a stand-by mode only in the early stage of the drilling operation.

Mud pumps are positive displacement pumps that can pump the drilling mud at pressures in the range of 3500 to 7500 psi. The principle components of a mud pump are the pistons and the suction and discharge valves. The suction valve is located in the inlet port of the pump and the discharge valve is located in the outlet port of the pump. The known valves include a valve body having a valve seat and a movable disc. The movable disc is biased into sealing contact with the valve seat by a spring to close the valve. The valves open in response to the suction or discharge pressure generated by the reciprocating movement of the piston. The drilling mud is highly abrasive and corrosive and the valve discs are subject to significant wear and erosion over time. Eventually, they become ineffective for the sealing function and have to be replaced. The replacement process requires taking the mud pump out of service for an extended period of time.

A plunger pump is another type of positive displacement pump. Plunger pumps are used to pump a variety of liquids including agro-chemicals, aqueous and non-aqueous industrial cleaning materials, petroleum products, and industrial chemicals and waste materials. The inlet and outlet ports of plunger pumps are equipped with spring-loaded valves to control the flow of the liquid through the pumping chambers. The control valves for plunger pumps are constructed and operate similarly to the valves described above for mud pumps. The components of the plunger pump valves are subjected to highly corrosive and sometimes erosive liquids. Therefore, they have to be replaced periodically. The frequency of replacement depends on the types of liquids to which the valves are exposed.

The known valves for mud pumps and plunger pumps are made of materials such as stainless steels that provide good resistance to corrosion and wear. However, it would be desirable to have a valve assembly for such pumps that is more resistive to wear and corrosion. The increase in the useful life of such components would significantly reduce the adverse effect on drilling operations when a mud pump must be taken out of service or on industrial processes when a plunger pump must be taken out of service.

### SUMMARY OF THE INVENTION

The disadvantages of the known valve assemblies for positive displacement pumps are resolved to a large degree by a valve assembly in accordance with the present invention. The valve assembly for a positive displacement pump according to the present invention includes a valve seat having a central opening formed therein. A closure disc is disposed on the valve seat for closing the central opening. The closure disc is formed of a technical ceramic material. The valve assembly also includes a spring for maintaining the closure disc in contact with the valve seat and means for centering the closure disc and the spring on the valve seat.

In accordance with another aspect of the present invention, the valve assembly has a generally cylindrical wall including a seat surface. An elastomeric seal is affixed to the seat surface such that the closure disc contacts the elastomeric seal when in a closed position.

In accordance with a further aspect of the present invention, the valve assembly has a ceramic closure disc that is made from a technical ceramic material that is selected from the group consisting of aluminum oxide, chromium oxide, high alumina, titanium oxide, zirconium oxide, and combinations thereof. The zirconium oxide may be either fully or partially stabilized.

### BRIEF DESCRIPTION OF THE DRAWINGS

The following description of the invention will be better understood when read in conjunction with the drawing figures, in which:

FIG. 1 is a side elevation view in partial section of a plunger pump valve assembly in accordance with the present invention as viewed along line 1-1 in FIG. 2;

FIG. 2 is bottom plan view of the valve assembly shown in FIG. 1;

FIG. 3 is a side elevation view in partial section of a mud pump valve assembly in accordance with the present invention;

FIG. 4 is a partial cross-sectional view of a sidewall and cap seal used in the valve assembly according to the present invention; and

FIG. 5 is a partial cross-sectional view of a sidewall and O-ring used in the valve assembly according to the present invention.

### DESCRIPTION OF THE PREFERRED EMBODIMENTS OF THE INVENTION

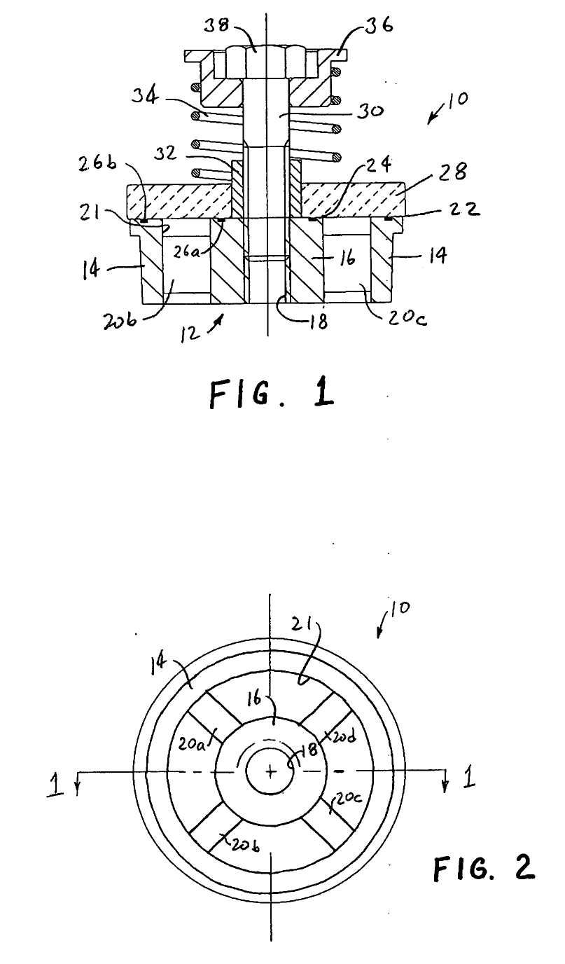

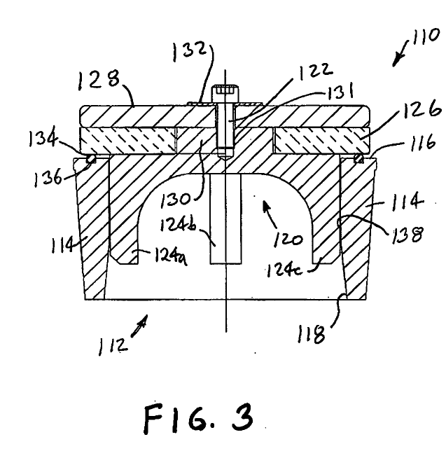

Referring now to FIGS. 1 and 2, there is shown a valve assembly 10 according to the present invention. The valve assembly 10 is a preferred arrangement for a suction or discharge valve used in a plunger-type positive displacement pump. The valve assembly 10 includes a valve seat 12 having a generally cylindrical outer wall 14 and a central support member 16 that is concentric with the outer wall 14. The central support member 16 is disposed coaxially with the outer wall 14 and is held in place by a web arrangement that consists of support arms 20a, 20b, 20c, and 20d which are spaced at intermittent angles and directed radially between the central support member 16 and the outer wall 14. A threaded bore 18 extends axially through the center of the central support member 16. The space between the central support member 16 and the outer wall 14 provides an annular channel 21 through which a pumped liquid can flow. The valve seat 12 is preferably formed of a corrosion and wear resistant material such as stainless steel.

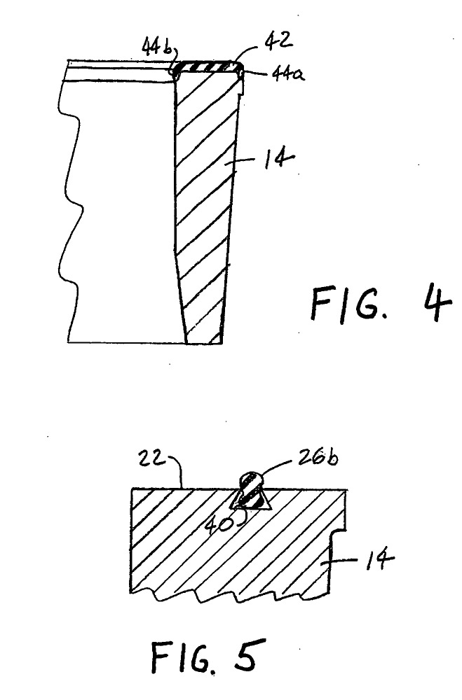

The outer wall 14 has an outer seat surface 22 and the central support member 26 has an inner seat surface 24. Elastomeric seals are affixed to the outer seat surface 22 and the inner seat surface 24. The elastomeric seals are preferably embodied by O-rings 26a and 26b. FIG. 5 shows a preferred arrangement for affixing the O-ring 26b to the seat surface 22. The O-ring 26b is partially inserted into a groove 40 that is formed in the respective seat surface. The groove 40 is formed to pinch the O-ring 26b in order to hold it in place. An identical arrangement is used to hold the second O-ring 26a in place on the inner seat surface 24. An alternative arrangement for the elastomeric seals is shown in FIG. 4. In the arrangement of FIG. 4, the elastomeric seal is embodied as a cap seal 42. The cap seal 42 is formed to cover all or a substantial portion of the seat surface 22 or 24. The cap seal 42 is bonded to the respective seat surface with a suitable adhesive material. In order to maximize the bond between the cap seal and the seat surface, the cap seal 42 preferably includes sidewalls 44a and 44b which extend partially down the inner and outer surfaces of outer wall 14. It is also preferred that small grooves be formed around the inner and outer circumferences of the seat surfaces to accommodate the sidewalls 44a and 44b so that a smooth transition is provided between the ends of the sidewalls 44a and 44b of the cap seal 42 and the outer and inner surfaces, respectively, of outer wall 14. A similar arrangement would be provided on the inner seat surface 24.

Referring back to FIG. 1, the valve assembly 10 also includes a closure disc or plate 28. The closure disc 28 is substantially ring-shaped and is formed of a ceramic material. The ceramic material is selected from the class of technical ceramics, particularly technical ceramic materials that exhibit superior wear resistance and strength. Among the preferred ceramic materials are aluminum oxide (alumina), chromium oxide, high alumina, titanium oxide (titania), zirconium oxide (zirconia) ceramics, including fully and partially stabilized zirconia, and combinations of such metal oxides. It is believed that just about any type of metal-oxide ceramic will provide acceptable properties. Excellent results have been achieved using partially stabilized zirconia (PSZ) for making the closure disc 28. Particular species of PSZ that are believed to be useful for the closure disc 28 include MgO-PSZ and Y₂O₃-PSZ. Silicon nitride, quartz, and silicon carbide ceramics are also expected to be useful for this application.

The closure disc 28 is positioned adjacent to the inner and outer seat surfaces of the valve seat 12. The closure disc 28 is centered over the valve seat 12 and is dimensioned to contact the outer wall 24 and the central support member 16 and thereby to cover the annular opening 21. A shoulder bolt 30 is provided to center the closure disc 28 on the valve seat 12. The shoulder bolt 30 is threaded into the threaded bore 18 of the central support member 16. A spacer sleeve 32 is positioned between the closure disc 28 and the shoulder bolt 30. A coil spring 34 has one end thereof in contact with the closure disc 28. The other end of the coil spring 34 is in contact with a retainer cap 36 that is held in place against the force of the spring 34 by the bolt head 38 of shoulder bolt 30. With that arrangement, the closure disc 28 is held against the seat surfaces 22 and 24 and is thereby biased in a normally closed position. The shoulder bolt 30, sleeve 32, spring 34, and retainer cap 36 are formed of a corrosion and wear resistant material, preferably a stainless steel.

In operation, the valve assembly 10 controls the flow of the process liquid being pumped. When the valve assembly 10 is configured as an inlet or intake valve, the suction created by displacement of the plunger causes the closure disc 28 to move away from the valve seat 12 against the biasing force of the spring 34. In this manner, the process liquid is allowed to flow into the pumping chamber. When the valve assembly 10 is configured as an outlet or discharge valve, the pressure of the process liquid created by displacement of the plunger causes the closure disc 28 to move away from the valve seat 12 against the biasing force of the spring 34. In this manner, the process liquid is caused to exit the pumping chamber.

Referring now to FIG. 3, there is shown a second embodiment of a valve assembly according to the present invention. The valve assembly 110 is a preferred arrangement for a suction or discharge valve used in a mud pump. The valve assembly 110 includes a valve seat 112 having a generally cylindrical outer wall 114. The outer wall 114 defines a central opening 118 which functions as a fluid flow channel. The valve seat 112 is preferably formed of a corrosion and wear resistant material such as stainless steel.

The outer wall 114 has a seat surface 116. An elastomeric seal is affixed to the seat surface 116. The elastomeric seal is preferably embodied by an O-ring 134. An alternative arrangement for the elastomeric seal is shown in FIG. 4. In the arrangement of FIG. 4, the elastomeric seal is embodied as a cap seal 42 as described hereinabove.

Referring back to FIG. 3, the valve assembly 110 also includes a valve body 120 which is positioned in the central opening 118. The valve body 120 has guide fingers 124a, 124b, 124c and a fourth guide finger that is not shown. The guide fingers extend radially from a central portion 130. The guide fingers are dimensioned to be slightly smaller than the inside diameter of the central opening 118 so that the valve body 120 can move axially in the central opening with minimal lateral shifting.

A closure disc 126 is positioned on top of the valve body 120. The closure disc 126 is substantially ring-shaped and is formed of a ceramic material. The ceramic material is selected from the class of technical ceramics as described hereinabove. The closure disc 126 is centered on the valve body 120 and is dimensioned to contact the seat surface 116 of the outer wall 114. The closure disc 128 has a central opening that is dimensioned to fit over the central portion 130 of the valve body 120. A retainer ring 128 is provided for holding the ceramic closure disc 126 against the valve body 120 so that the disc will move in tandem with the valve body 120. To that end, a shoulder bolt 122 is threaded into to a threaded borehole 131 formed centrally in the center portion 130 of the valve body 120. A metallic washer 132 is positioned between the head of the shoulder bolt 122 and the retainer ring 128.

When in use, the valve assembly 110 is positioned in a suction port or a discharge port of a mud pump. The valve assembly 100 is positioned such that the retainer ring 128 contacts a coil spring (not shown) or other type of resilient member. The other end of the coil spring is in contact with a wall or other retaining means in the suction or discharge port of the mud pump. With that arrangement, the closure disc 126 is held against the seat surface 116 and is thereby biased in a normally closed position.

The guide fingers rub against the inner surface 138 of the wall 114 when the valve assembly is in operation. The constant rubbing causes substantial wear of the inner surface 138 over time. Therefore, the inner surface, or at least a portion thereof that is adjacent to the guide fingers, is preferably coated with a wear-resistant coating or layer. A variety of coatings that are suitable for reducing friction and wear of the inner surface can be used. Preferably, the surface is coated with a proprietary composite coating such as sold by Eagle Innovations Inc. under the trademark “E-CARBON”. Alternatively, the inner surface can be coated with a thin layer of tungsten carbide or other ultra-hard material.

The foregoing describes a novel valve assembly for a positive displacement pump such as a mud pump or a plunger pump. The valve assembly has a ceramic closure disc that is formed of a technical ceramic material. The technical ceramic material provides significantly improved resistance to corrosion and to erosive wear, thereby providing an extended useful life for the valve assembly. A valve assembly according to the present invention also features an elastomeric seal disposed on a seat surface of the valve seat. The elastomeric seal not only provides enhanced sealing when the closure disc is in the closed position, but also provides significantly reduced noise that results from the closure disc contacting the valve seat during operation.

The terms and expressions which have been employed are used as terms of description and not of limitation. There is no intention in the use of such terms and expressions of excluding any equivalents of the features shown and described or portions thereof. It is recognized, therefore, that various modifications are possible within the scope and spirit of the invention. Accordingly, the invention incorporates variations that fall within the scope of the following claims.

What is claimed is:

1. A valve assembly for a positive displacement fluid pump comprising:
a valve seat having a central opening formed therein;
a closure disc positioned on said valve seat for closing the central opening, said closure disc being formed of a technical ceramic material; and
means for centering said closure disc and said spring on the valve seat.

2. A valve assembly as set forth in claim 1 wherein the valve seat comprises a generally cylindrical wall having a seat surface and an elastomeric seal affixed to said seat surface such that said closure disc contacts said elastomeric seal when in a closed position.

3. A valve assembly as set forth in claim 2 wherein said elastomeric seal comprises an O-ring.

4. A valve assembly as set forth in claim 2 wherein said elastomeric seal comprises a cap seal.

5. A valve assembly as set forth in claim 1 further comprising a spring disposed for maintaining said closure disc in contact with said valve seat.

6. A valve assembly as set forth in claim 5 wherein the centering means comprises a bolt extending axially through said spring and said closure disc and a spacer sleeve disposed between said closure disc and said bolt.

7. A valve assembly as set forth in claim 1 wherein the valve seat comprises:
a generally cylindrical wall having a seat surface;
a central support member disposed axially in the central opening; and
a web disposed between the cylindrical wall and the central support member for supporting said support member in the central opening.

8. A valve assembly as set forth in claim 6 further comprising an elastomeric seal affixed to said seat surface such that said closure disc contacts said elastomeric seal when in a closed position.

9. A valve assembly as set forth in claim 7 wherein said elastomeric seal comprises an O-ring.

10. A valve assembly as set forth in claim 2 wherein said elastomeric seal comprises a cap seal.

11. A valve assembly as set forth in any one of the preceding claims wherein the technical ceramic material is selected from the group consisting of aluminum oxide, chromium oxide, high alumina, titanium oxide, zirconium oxide, and combinations thereof.

12. A valve assembly as set forth in claim 10 wherein the technical ceramic material is a fully or partially stabilized zirconium oxide.

13. A valve assembly as set forth in claim 1 wherein the centering means comprises a valve body adapted for axial displacement in the central opening and said closure disc is mounted on said valve body for displacement in tandem therewith.

14. A valve assembly as set forth in claim 12 wherein the valve body comprises guide fingers extending radially from a central portion of said valve body, said guide fingers being dimensioned and positioned for centering said valve body in the central opening.

15. A valve assembly as set forth in claim 12 wherein the valve seat comprises a generally cylindrical wall having a seat surface and an elastomeric seal affixed to said seat surface such that said closure disc contacts said elastomeric seal when in a closed position.

16. A valve assembly as set forth in claim 12 wherein said elastomeric seal comprises an O-ring.

17. A valve assembly as set forth in claim 12 wherein said elastomeric seal comprises a cap seal.

18. A valve assembly as set forth in claim 13 further comprising a retainer ring positioned over said closure disc and a fastener extending axially through said retainer ring and said closure disc and engaged with said valve body, whereby said closure disc is retained on said valve body.

19. A valve assembly as set forth in any one of claims 12 to 16 wherein the technical ceramic material is selected from the group consisting of aluminum oxide, chromium oxide, high alumina, titanium oxide, zirconium oxide, and combinations thereof.

20. A valve assembly as set forth in claim 17 wherein the technical ceramic material is a fully or partially stabilized zirconium oxide.
